(19) United States
(12) Patent Application Publication
(10) Pub. No.: US 2026/0358163 A1
(43) Pub. Date: Nov. 12, 2026

(54) FLUID LEVEL SENSORS AND METHODS THEREOF

(71) Applicant: Advanced Drainage Systems, Inc., Hilliard, OH (US)

(72) Inventors: Cal PITRUZZELLO, Middlefield, CT (US); Mike HUFF, Jeromesville, OH (US); Adam MILLER, Haddam, CT (US)

(73) Assignee: Advanced Drainage Systems, Inc., Hilliard, OH (US)

(21) Appl. No.: 19/672,182

(22) Filed: May 8, 2026

Related U.S. Application Data
(60) Provisional application No. 63/803,384, filed on May 9, 2025.

(51) Int. Cl. G01F 23/20

(52) U.S. Cl. CPC G01F 23/20

(57) ABSTRACT

Systems, apparatuses, and methods of using a fluid level sensor are disclosed. The fluid level sensor may comprise a first elongate structure comprising a first end and a second end opposite the first end, the first elongate structure configured to be at least partially submerged in a fluid such that the second end is fully submerged in the fluid. The fluid level sensor may also include a load cell coupled to the first end of the first elongate structure and configured to generate a first electrical signal indicating a level of submergence of the first elongate structure in the fluid.

### CROSS-REFERENCE TO RELATED APPLICATIONS

This application is based on and claims benefit of priority of U.S. Provisional Application No. 63/803,384, filed on May 9, 2025. The contents of the foregoing application are incorporated herein by reference in their entireties.

### TECHNICAL FIELD

This disclosure relates generally to systems, methods, and apparatuses for measuring fluid levels in a container, and more particularly, to measuring fluid levels using a solid-state fluid level sensor.

### BACKGROUND

Wastewater from a residential or commercial building may often be treated by an onsite subsurface wastewater treatment system. The onsite subsurface wastewater treatment system may comprise a primary tank that receives the flow of wastewater from a source in the residential or commercial building.

Water treatment systems have existed for many years. These systems treat stormwater surface runoff or other polluted water. Stormwater runoff is of concern for two main reasons: (a) volume and flow rate, and (b) pollution and contamination. The volume and flow rate of stormwater runoff is a concern because large volumes and high flow rates can cause erosion and flooding. Pollution and contamination of stormwater runoff is a concern because stormwater runoff flows into our rivers, streams, lakes, wetlands, and/or oceans. Pollution and contamination carried by stormwater runoff into such bodies of water can have significant adverse effects on the health of ecosystems and people. Thus, fluid management in wastewater treatment systems or stormwater treatment systems is crucial.

### SUMMARY

Consistent with disclosed embodiments, systems, apparatuses, and methods for measuring fluid levels in a container are disclosed. The disclosed embodiments may include a fluid level sensor comprising a first elongate structure comprising a first end and a second end opposite the first end, the first elongate structure being configured to be at least partially submerged in a fluid such that the second end is fully submerged in the fluid. The fluid level sensor may also include a load cell coupled to the first end of the first elongate structure. The fluid level sensor may also be configured to generate a first electrical signal indicating a level of submergence of the first elongate structure in the fluid.

The fluid level sensor may further comprise a second elongate structure configured to surround the first elongate structure along a length of the first elongate structure. The first elongate structure and the second elongate structure may be placed concentrically along a vertical axis. The first elongate structure and the second elongate structure may be radially separated by a gap, and wherein the gap may be substantially uniform along the length of the first elongate structure.

The fluid level sensor may further comprise at least one spacer coupled to an outer wall of the first elongate structure and to an inner wall of the second elongate structure, and wherein the at least one spacer is configured to maintain uniformity of the gap. The load cell may comprise circuitry configured to detect a change in buoyant force exerted on the first elongate structure caused by a change in the level of submergence of the first elongate structure. The load cell may be further configured to detect a change in a weight of a submerged portion of the first elongate structure based on the change in buoyant force. The load cell may comprise a strain gauge, including, for example, a quarter-bridge strain gauge, a half-bridge strain gauge, or a full-bridge strain gauge.

The fluid level sensor may further include a transducer electrically connected with the load cell, the transducer being configured to receive the first electrical signal and generate a second electrical signal based on the first electrical signal. The fluid level sensor may further include an enclosure configured to house the transducer. The fluid level sensor may further include a mount, wherein the load cell may be coupled to the mount through a mechanical coupling mechanism. The mount may be configured to receive the enclosure, including the transducer, and the second elongate structure. The mount may be configured to be coupled to an adapter associated with a fluid container containing the fluid.

Additional features and advantages of the disclosed embodiments will be set forth in part in the description that follows, and in part will be obvious from the description, or may be learned by practice of the disclosed embodiments.

It is to be understood that both the foregoing general description and the following detailed description are examples and explanatory only and are not restrictive of the disclosed embodiments.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments.

FIG. 1 illustrates a schematic of an example fluid management system including a fluid level sensor, consistent with embodiments of the present disclosure.

FIG. 2 illustrates a perspective view of an example fluid level sensor coupled with an adapter of the fluid management system of FIG. 1, consistent with embodiments of the present disclosure.

FIG. 3A illustrates a perspective view of an example fluid level sensor, consistent with embodiments of the present disclosure.

FIG. 3B illustrates a top planar view of the fluid level sensor of FIG. 3A, consistent with embodiments of the present disclosure.

FIG. 3C illustrates a cross-section view of the fluid level sensor of FIG. 3A along the plane A-Aʹ shown in FIG. 3B, consistent with embodiments of the present disclosure.

FIG. 3D illustrates a front elevation view of elongate structures of the fluid level sensor of FIG. 3A, consistent with embodiments of the present disclosure.

FIG. 3E illustrates an exploded view of the elongate structures shown in FIG. 3D, consistent with embodiments of the present disclosure.

FIG. 4 illustrates a perspective view of an example load cell associated with the fluid level sensor, consistent with embodiments of the present disclosure.

FIG. 5 illustrates a perspective view of a transducer associated with the fluid level sensor, consistent with embodiments of the present disclosure.

FIG. 6 illustrates a perspective view of a mount associated with the fluid level sensor of FIG. 1, consistent with embodiments of the present disclosure.

FIG. 7 illustrates a top view of a spacer associated with the fluid level sensor of FIG. 1, consistent with embodiments of the present disclosure.

FIG. 8 illustrates a schematic of a signal processing circuit associated with the fluid level sensor of FIG. 1, consistent with embodiments of the present disclosure.

### DETAILED DESCRIPTION

Example embodiments are described with reference to the accompanying drawings.

Some existing systems to detect, measure, or monitor fluid levels in fluid containers or wastewater treatment systems include mechanical floats, ultrasonic level sensors, or pressure transducers. A mechanical float is a ball-like structure which sits on the surface of a fluid and travels up and down with the level of the fluid, opening and closing a circuit with limit switches. While mechanical floats are easy to operate and simple in design, the floats are susceptible to bio-fouling and struggle to remain buoyant, particularly in harsh environments such as in a wastewater treatment system. Other existing fluid level sensing techniques include using ultrasonic level sensors which utilize an ultrasonic horn and bounce sound waves off the surface of the water, measuring distance based on the time for the sound waves to return to the sensor. While this technique does not rely on moving parts, condensation can foul the horn, rendering it inaccurate or inadequate for sensing water levels in harsh environments. Pressure transducers utilize the head pressure in a water column. However, transducers at the bottom of the water column can become blanketed by sludge layers and contaminants, shielding the diaphragm from ambient pressure, and resulting in poor measurement accuracy and reliability. Therefore, there is a need for fluid level sensors without any moving parts but that are capable of accurately and reliably measuring fluid levels in harsh environments.

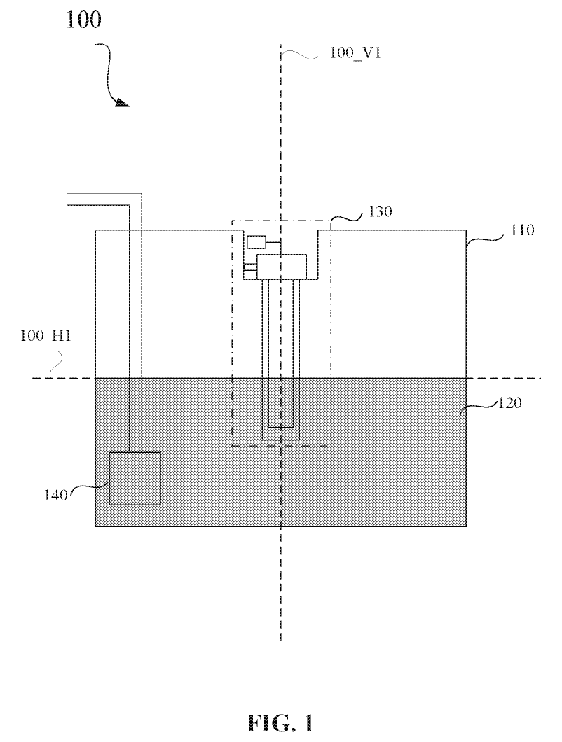

Reference is now made to FIG. 1, which illustrates a schematic of an example fluid management system including a fluid level sensor, consistent with embodiments of the present disclosure. As shown, a fluid management system 100 may include a fluid container 110 configured to hold a fluid 120, a fluid level sensor 130, and a fluid pump 140. It is to be appreciated that although not shown, fluid management system 100 may include other components such as, but not limited to, a fluid control system, pH sensors, fluid treatment systems, flow meters, valves, among other things.

Fluid management system 100 may comprise a water treatment system, wastewater treatment unit, a stormwater storage system, or other fluid run-off management system. As an example, fluid management system 100 may be a stormwater storage system configured to store and/or process rainwater, stormwater, or other fluid run-offs on ground surfaces. Such systems may be located at roadways, parking lots, filling stations, and other sites prone to rainwater, stormwater, sediment, trash, metals, oil accumulation, and/or flow. These systems may be used to process rainwater or stormwater by separating fluid from solid particles or providing filtration. It is to be appreciated that although stormwater storage system is used as an example of a fluid management system, the disclosure is not limited as such.

Fluid management system 100 may include fluid container 110. In some embodiments, fluid container 110 may be a tank, a reservoir, a fluid tote, an intermediate bulk container (IBC), a flexible bag, or one or more flexible bladders, among other things. In some embodiments, fluid container 110 may be made from a thermoplastic polymer such as acrylonitrile butadiene styrene (ABS), polyvinyl chloride (PVC), any suitable polymers, metal, glass, rubber, steel, or any suitable material. Fluid container 110 may be configured to temporarily or permanently store fluid 120 including, but not limited to, rainwater, stormwater, wastewater, oil, sludge, run-off fluids, or other fluids.

Fluid management system 100 may further include fluid level sensor 130 configured to measure the level of fluid 120 in fluid container 110. In some embodiments, fluid management system 100 may include (not shown) a fluid control unit to regulate the fluid level in fluid container 110. The fluid control unit may be configured to communicate with fluid pump 140 and fluid level sensor 130 to maintain a predetermined maximum amount of fluid or a predetermined minimum amount of fluid. For example, if the fluid level in fluid container 110 measured by fluid level sensor 130 rises above a predetermined safe limit, the fluid control unit may activate fluid pump 140 to pump out the excessive fluid to maintain the predetermined minimum amount of fluid in fluid container 110 or to maintain the fluid level to acceptable limits. In some embodiments, fluid management system 100 may be configured to continuously monitor the fluid level and to maintain the fluid level in fluid container 110 based on the continuous monitoring. The height of the fluid or the fluid level may be measured on a continuous scale, allowing a higher degree of precision in fluid level control. Fluid management system 100 may include a feedback-based control loop mechanism such as a proportional-integral-derivative (PID) controller, for example, to continuously control the fluid level in fluid container 110. In some embodiments, the fluid control unit may be programmed to operate fluid pump 140 to drain fluid from fluid container 110 periodically as a routine maintenance operation, or aperiodically, as appropriate. In some embodiments, the fluid control unit may communicate with fluid level sensor 130 and fluid pump 140 remotely, wirelessly, or through a wired connection. In some embodiments, fluid management system 100 may include one or more processors (not shown) including a display unit configured to monitor the fluid levels in fluid container 110, or a memory or a storage associated with the processor to store data associated with the fluid level sensor, among other components. Fluid level sensor 130 may be disposed such that a vertical axis of fluid level sensor 130 aligns with or is substantially parallel to a vertical axis 100_V1 of fluid container 110. Fluid level sensor 130 may be disposed such that a vertical axis of fluid level sensor 130 is substantially perpendicular to a top horizontal surface of fluid 120 along horizontal axis 100_H1.

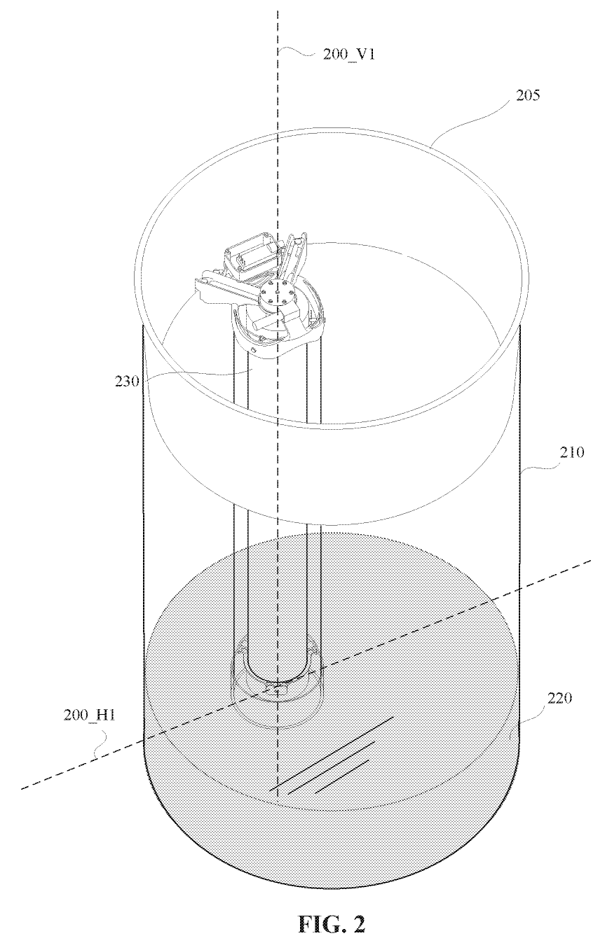

FIG. 2 illustrates a perspective view of fluid level sensor 230 coupled with an adapter 205 of a fluid management system (e.g., fluid management system 100 of FIG. 1), consistent with embodiments of the present disclosure. Fluid level sensor 230 may be analogous to and may perform similar functions as fluid level sensor 130 of fluid management system 100. In some embodiments, adapter 205 (e.g., a riser) may be coupled with fluid container 210 to adjust compatibility with at-grade or above-grade fixtures such as, but not limited to, manholes, or any suitable fluid access locations. In some embodiments, adapter 205 may serve as a fixture to which fluid level sensor 230 may be secured to or attached to, and to enable easy installation, replacement, and maintenance of fluid level sensor 230. In some embodiments, fluid level sensor 230 may be coupled with adapter 205 such that there may be negligible relative movement, if any, between adapter 205 and fluid level sensor 230.

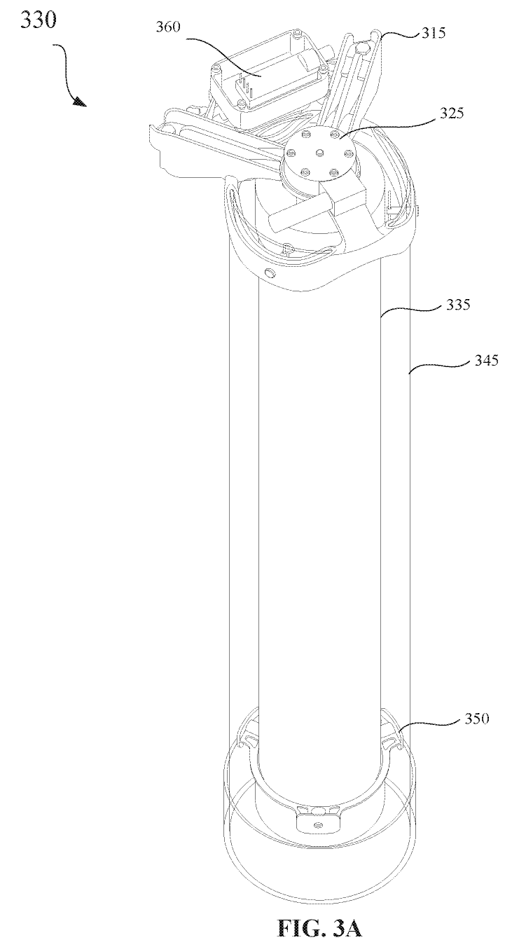

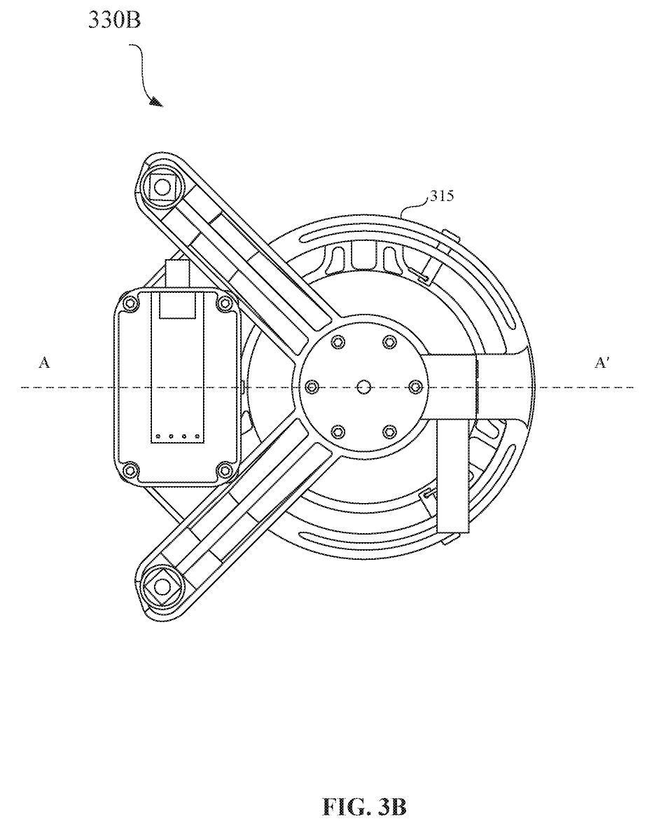

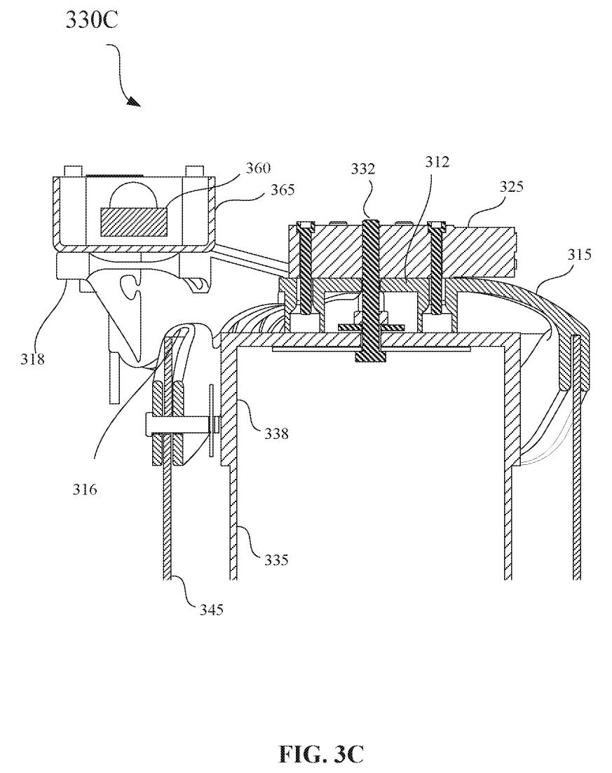

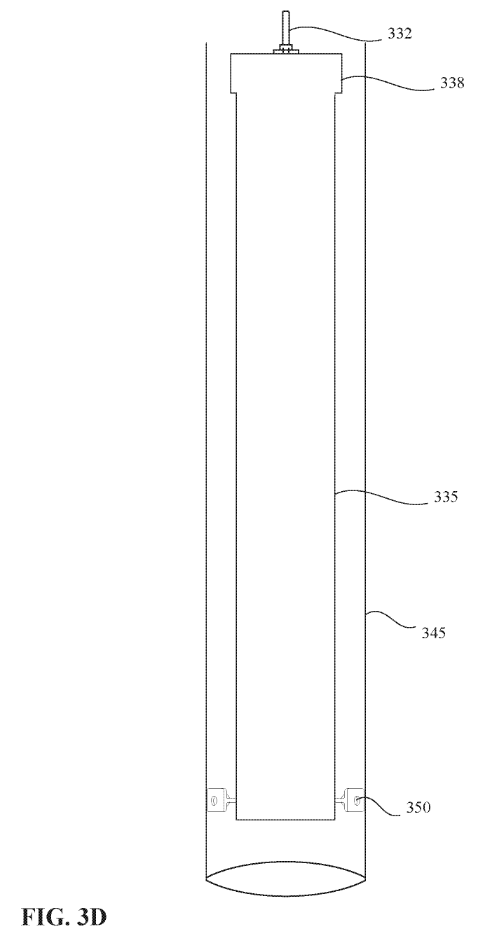

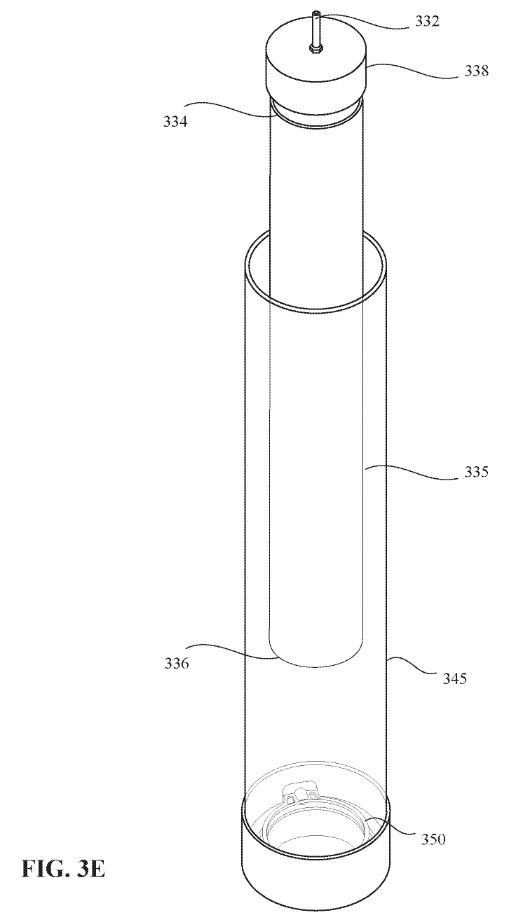

In some embodiments, fluid level sensor 230 may be coupled with adapter 205 through a mount (discussed with reference to FIG. 3A) or any suitable coupling mechanism. Fluid level sensor 230 may be disposed such that the vertical axis 200_V1 of fluid level sensor 230 is substantially perpendicular to the horizontal axis 200_H1 of the top surface of fluid 220 in fluid container 210. In other words, the fluid level sensor 230 may be placed substantially parallel to a vertical axis perpendicular to the horizontal axis of the surface of the fluid 220. In the context of this disclosure, substantially perpendicular with respect to a horizontal axis refers to the orientation of a component such that an angle between a vertical axis of the component and a horizontal axis of the fluid is 90° ± 10°. In the context of this disclosure, substantially parallel with respect to a vertical axis refers to the orientation of a component such that an angle between a vertical axis of the component and a vertical axis perpendicular to the horizontal axis of the fluid is 0° ± 10°.

Reference is now made to FIG. 3A, which illustrates a perspective view of an example of a fluid level sensor 300, consistent with embodiments of the present disclosure. Fluid level sensor 330 may be substantially similar to and may perform substantially similar functions as fluid level sensor 130 of FIG. 1. Fluid level sensor 330 may comprise a mount 315, a load cell 325, an inner tube 335, an outer shield 345, a spacer 350, and a transducer 360. It is to be appreciated that although not explicitly illustrated, fluid level sensor 330 may include other components or elements as well, as appropriate.

Fluid level sensor 330 may include mount 315 configured to be coupled with an adapter (e.g., adapter 205 of FIG. 2) or a tank riser (not depicted in FIG. 3). In some embodiments, mount 315 may be coupled with adapter 205 through a mechanical coupling mechanism such as, but not limited to, bolts, thermal welding, or fasteners, among other coupling techniques. Mount 315 may be made from a polymer material such as PVC, high-density polyethylene (HDPE), a metal, rubber, an alloy, a composite, or a combination thereof. In some embodiments, mount 315 may be a monolithic piece and may be made from a single type of material, for example, by 3D printing or other additive manufacturing techniques. In some embodiments, mount 315 may be formed by combining and integrating different parts.

Fluid level sensor 330 may further include load cell 325 coupled to a portion of mount 315. A load cell, as used in this context, refers to a force sensor or a force transducer configured to measure force by converting an input of mechanical energy (e.g., force, load, tension, compression) into an electrical energy (e.g., a voltage or a current signal). In some embodiments, load cell 325 may be a strain gauge load cell or a piezoelectric load cell. Structurally, a strain gauge load cell (e.g., load cell 325) may comprise a metal body (e.g., a metal housing or a flexure) to which one or more strain gauges may be securely attached. The metal body of a load cell may be made from, but is not limited to, metals including aluminum, alloy steel, or stainless steel, or other suitable materials which can provide durability and minimal elasticity. When a force or load is applied to the load cell, the body undergoes slight deformation. However, as long as the load cell is not overloaded, the body of the load cell may return to its original shape. This, in turn, causes a change in the electrical resistance of the strain gauge which can then be measured as a voltage change. Since this change in output is proportional to the amount of weight applied, the weight of the object may be determined from the change in output signal. By measuring the change in voltage output, the weight or force applied to the load cell can be accurately determined. In some embodiments, load cell 325 may comprise an in-line load cell, a load button load cell, an S-beam load cell, a through-hole load cell, a side mounted load cell, a column load cell, a pancake load cell, a flat plate load cell, or other suitable load cell based on the desired shape, geometry, or application.

In this context, a strain gauge refers to a device that measures change in electrical resistance when a force is applied. A strain gauge may include a length of metallic wire or electrical conductor set up in a pattern in a way that produces a linear change in resistance when strain is applied along one axis. In other words, strain gauges are electrical conductors attached to a film in a predetermined shape (e.g., a zigzag pattern, or a serpentine pattern). When stress is transferred from the load cell flexure to the strain gauge, the resulting deformation or displacement of its material causes strain which is converted into the load cell’s measurable output (e.g., a measurable electrical signal).

In some embodiments, multiple strain gauges may be associated with a single load cell to enhance the detection or measurement accuracy. In other words, multiple strain gauges may be used in tandem to improve the detection accuracy and to improve the signal-to-noise ratio. A single active strain gauge is referred to as a quarter-bridge, two active strain gauges are referred to as a half-bridge, and four active strain gauges are referred to as a full-bridge strain gauge. In some embodiments, load cell 325 may comprise a quarter-bridge strain gauge, or a half-bridge strain gauge, or a full-bridge strain gauge. In some embodiments, load cell 325 may further comprise other types of strain gauges such as, but not limited to, linear strain gauges, double linear strain gauges, shear strain gauges, 90° strain gauges, or rosette strain gauges.

An example of a full-bridge strain gauge may include a Wheatstone bridge configured to measure a change in resistance in one or more branches of the circuit based on the strain. A Wheatstone bridge is a configuration of four balanced resistors to which an excitation voltage may be applied, and an output voltage is measured. If all resistors are balanced, the output voltage (V_{O}) is 0, however, if there is a change in the value of one of the resistors then V_{O} will have a resulting change that can be measured and interpreted using Ohm’s law. Ohm’s law states that the current (I, measured in amperes) running through a conductor between two points is directly proportional to the voltage (V) across the two points. In a load cell configuration, the resistors may be replaced with strain gauges in alternating tension and compression measurements. When a force is applied to the load cell, the resistance in each strain gauge changes and the V_{O} may be measured.

In the context of this disclosure, in operation, load cell 325 (e.g., a full-bridge strain gauge load cell) may be configured to detect or measure the change in weight of the submerged portion of inner tube 335 by measuring the buoyant force of the submerged volume. The buoyant force exerted on the inner tube 335 may vary based on the level of submergence of inner tube 335 in fluid (e.g., fluid 120 or fluid 220 of FIGS. 1 and 2, respectively). In other words, as the level of submergence of inner tube 335 increases by virtue of increasing fluid level, the volume of inner tube 335 submerged in the fluid increases, increasing the buoyant force. The increase in buoyant force acting on the submerged portion of inner tube 335 effectively reduces the weight of inner tube 335. The information associated with the change in effective weight of inner tube 335 may be utilized to determine a change in submergence level or the fluid level, enabling measurement of fluid levels in a fluid container (e.g., fluid container 210) using fluid level sensor 330.

Fluid level sensor 330 may further include an inner tube 335 directly or indirectly coupled with mount 315. In some embodiments, inner tube 335 (also referred to herein as an elongate structure or the first elongate structure) may be made from a polymer material such as, but not limited to, polyvinyl chloride (PVC), rubber, glass, a combination thereof, or other suitable materials. In some embodiments, inner tube 335 may be a pipe, a tube, or a hollow cylindrical structure. In some embodiments, one end (e.g., first end 334, discussed with reference to FIG. 3E) of inner tube 335 may be coupled with mount 315 and load cell 325 mounted on mount 315 such that slight movements of inner tube 335 along the vertical axis (e.g., vertical axis 200_V1) due to change in the effective weight of inner tube 335 caused by a change in submergence level of inner tube 335, may be detected by the strain gauges in load cell 325. The other end (e.g., second end 336, discussed with reference to FIG. 3E) of inner tube 335 may be sealed (e.g., closed end) to prevent the fluid from entering the inner volume of inner tube 335. In some embodiments, second end 336 of inner tube 335 may comprise a submerged end and first end 334 of inner tube 335 may comprise a non-submerged end. In some embodiments, the inside diameter of inner tube 335 may be in a range between 2 inches to 6 inches, or 2.5 inches to 6 inches, or 3 inches to 6 inches, or 3.5 inches to 6 inches, or 4 inches to 6 inches, or other suitable ranges. In some embodiments, the inside diameter of inner tube 335 may be 4 inches.

Inner tube 335 may be coupled with mount 315 such that inner tube 335 extends vertically downward in the inner volume of a fluid container containing fluid (e.g., fluid 220) and substantially parallel with respect to its vertical axis.

Fluid level sensor 330 may further include outer shield 345 coupled to mount 315 and configured to surround inner tube 335 along the length of inner tube 335. In some embodiments, outer shield 345 may comprise a tube, a pipe, a hollow cylindrical structure, or an elongate structure having an inner diameter larger than the outer diameter of inner tube 335. In some embodiments, outer shield 345 may be made from a polymer material such as, but not limited to, polyvinyl chloride (PVC), rubber, glass, metal, a combination thereof, or other suitable materials. In some embodiments, although not explicitly illustrated, outer shield 345 may comprise a solid impervious outer surface or a mesh surface configured to allow fluid to pass through, while blocking debris and other contaminants, into the gap between the inner walls of outer shield 345 and outer walls of inner tube 335. In some embodiments, outer shield 345 may comprise a combination of a solid impervious outer surface and a mesh surface, as appropriate. In some embodiments, outer shield 345 may comprise an optically transparent material, an optically translucent material, or an opaque material.

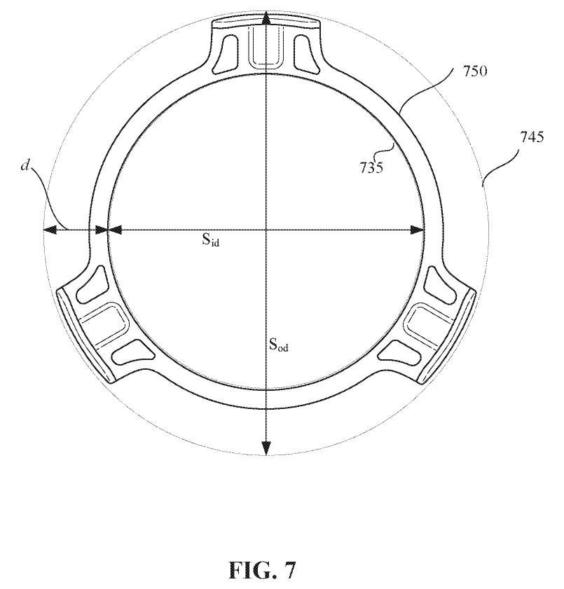

As illustrated in FIG. 3A, outer shield 345 may be coupled with mount 315 such that outer shield 345 extends vertically downward in the inner volume of a fluid container containing fluid (e.g., fluid 220) and substantially parallel to the vertical axis of inner tube 335. In other words, outer shield 345 and inner tube 335 may be disposed concentrically and parallel to each other such that a substantially uniform or a uniform gap ‘d’ (discussed with reference to FIG. 7) may be maintained between the outer walls of inner tube 335 and inner walls of outer shield 345 along the length of the inner tube 335 and outer shield 345. In this context, a gap refers to the horizontal distance between the inner walls of outer shield 345 and outer walls of inner tube 335 measured along a horizontal plane perpendicular to the vertical axis of inner tube 335. In some embodiments, outer shield 345 may be longer than inner tube 335 such that it extends further into the fluid in comparison with inner tube 335. In some embodiments, outer shield 345 may be securely coupled with mount 315 using a mechanical coupling mechanism such as, but not limited to, a clevis pin, a bolt, or other suitable coupling mechanisms.

Fluid level sensor 330 may further include spacer 350 (discussed with reference to FIG. 7) disposed in the gap between inner tube 335 and outer shield 345. In some embodiments, fluid level sensor 330 may include a plurality of spacers. Spacer 350 may be coupled to a portion of the inner walls of outer shield 345 and a portion of the outer walls of inner tube 335 such that it substantially minimizes or prevents relative movement between the inner tube 335 and outer shield 345. In other words, spacer 350 may serve to maintain the uniform horizontal gap between inner tube 335 and outer shield 345 and provide structural support as well. It is to be appreciated that although only one spacer is shown in the figures, multiple spacers may be used as well. In some embodiments, multiple spacers may be used along the length of inner tube 335 and outer shield 345, as appropriate.

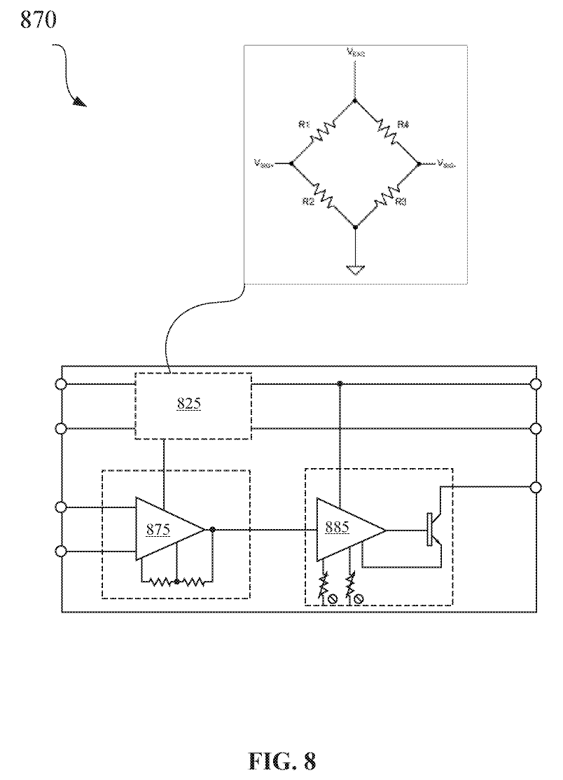

Fluid level sensor 330 may further include transducer 360 coupled with mount 315 and electrically connected to load cell 325. Transducer 360 may be configured to receive one or more electrical signals from load cell 325 and generate an output electrical signal based on the received input electrical signals. In some embodiments, generating an output electrical signal may include converting, amplifying, or modifying the input electrical signal. An example circuit associated with transducer 360 is discussed with reference to FIG. 8.

FIGS. 3B and 3C illustrate a top view 330B and a cross-section view 330C of fluid level sensor 330 along plane A-Aʹ (shown in FIG. 3B), respectively, consistent with embodiments of the present disclosure. FIG. 3C illustrates a cross-section view of mount 315, inner tube 335 coupled with mount 315, outer shield 345 coupled with mount 315, and transducer 360 coupled with mount 315.

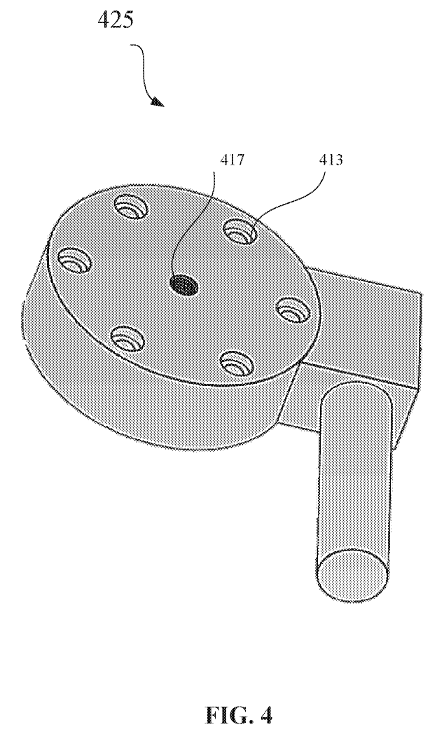

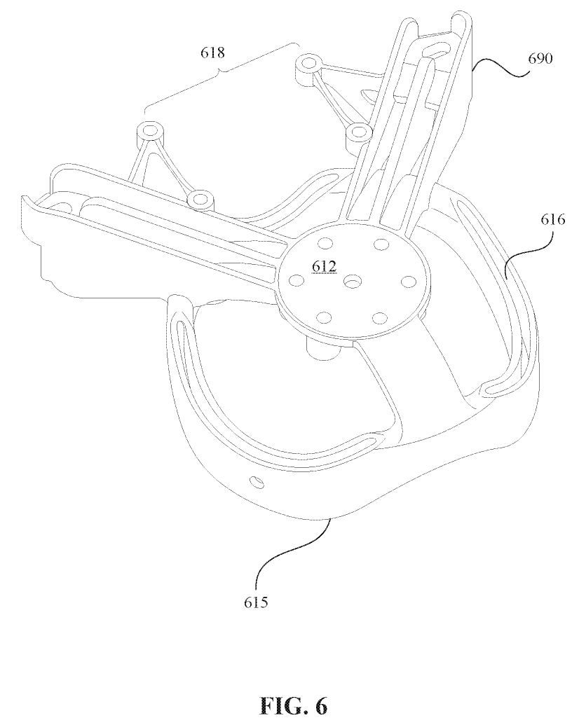

In some embodiments, portion 312 of mount 315 may be configured to receive load cell 325. Portion 312 (also refer to portion 612 of FIG. 6) of mount 315 may include a plurality of threaded through openings arranged radially to receive, for example, bolts to secure load cell (e.g., load cell 425 of FIG. 4 or load cell 325 of FIG. 3A) in place. Prior to securing the load cell on portion 312, each of the plurality of threaded through openings in portion 312 of mount 315 may be aligned with threaded through openings 410 of load cell 425. Portion 312 may further include a central threaded through opening configured to receive alignment pin 332 coupled with inner tube 335. Alignment pin 332 may connect inner tube 335 with load cell 325 through portion 312 of mount 315 such that mount 315 is disposed between a top horizontal surface of inner tube 335 and a bottom surface of load cell 325.

Mount 315 may further include a groove 316 (also refer to groove 616 with reference to FIG. 6) configured to receive outer shield 345. Groove 316may be a circumferential groove having an adjustable width based on the thickness of outer shield 345. Upon inserting an end of outer shield 345 inside groove 316, outer shield 345 may be held securely in place using a coupling mechanism including a clevis pin, or a bolt, or other suitable mechanisms.

Mount 315 may further include portion 318 (also refer to portion 618 of FIG. 6) configured to receive an enclosure 365 housing the transducer 360. In some embodiments, enclosure 365 including transducer 360 may be securely coupled with mount 315 using a mechanical coupling mechanism such as, but not limited to, bolts, screws, or other suitable couplers.

FIGS. 3D and 3E illustrate a front view (elevation) and an exploded perspective view of exemplary inner tube and outer shield of a fluid level sensor, consistent with embodiments of the present disclosure. In some embodiments, as illustrated in FIG. 3E, inner tube 335 may comprise a cap 338 disposed on first end 334 of inner tube 335. In some embodiments, cap 338 and inner tube 335 may form a single monolithic piece, as depicted in FIG. 3C. In some embodiments, however, cap 338 may be removably attached to first end 334 of inner tube 335. Alignment pin 332 may be coupled with cap 338, protruding vertically upward and out from the top surface of cap 338 such that alignment pin 332 may be fed through the central threaded opening of portion 312 of mount 315 and the central opening (e.g., opening 470 of load cell 425 discussed with reference to FIG. 4) of load cell 425, thereby aligning the inner tube 335, mount 315, and load cell 325 along the vertical axis. The second end 336, opposite from first end 334, may comprise a closed, fluid-sealed end to prevent ingress of any fluid or contaminant into the inner volume of inner tube 335.

During operation of the fluid level sensor (e.g., fluid level sensor 130 or 230 of FIG. 1 and 2, respectively), the absolute weight of inner tube 335 may increase due to accumulation of contaminants, debris, or undesirable particles present in the fluid, on the outer walls of inner tube 335, resulting in erroneous fluid level measurement. In such cases, it may be desirable to perform routine maintenance of the fluid level sensor and its components. In some embodiments, the fluid management system 100 may generate an alert to notify a user, or an authorized personnel, to perform maintenance at predetermined time periods. As an example, the fluid management system 100 may generate an alert every month, or every two weeks, to perform maintenance checks. In some embodiments, performing maintenance may include, cleaning the outer walls of inner tube 335, recalibrating the load cell based on the weight of inner tube 335 after the clean-up is performed, among other things. In some embodiments, fluid management system 100 may generate an alert to notify a user to perform maintenance based on measurement of one or more characteristics such as, but not limited to, pH of the fluid, density of the fluid, presence of toxic contaminants in the fluid, among other things. In some embodiments, fluid management system 100 may perform a self-clean up (e.g., without human intervention) of outer walls of inner tube 335 based on the measurement of one of more characteristics of the fluid using chemical means, mechanical means, thermal means, or other suitable cleaning means. As an example, inner tube 35 may be air-scoured periodically to clean off any undesirable growth or contamination.

In some embodiments, fluid management system 100 may include one or more fluid level sensors configured to measure the level of fluid in a fluid container. In some embodiments, employing multiple fluid level sensors may enhance measurement accuracy of fluid levels by virtue of larger dataset for statistical analysis. Additionally, employing multiple fluid level sensors may allow an uninterrupted (i.e., minimal to no down time) detection and measurement of fluid levels even during maintenance schedules.

Reference is now made to FIG. 4, which illustrates a perspective view of an exemplary load cell, consistent with embodiments of the present disclosure. Load cell 425 may be substantially similar to and may perform substantially similar functions as load cell 325 of FIG. 3A. As discussed previously with reference to FIGS. 3B and 3C, load cell 425 may comprise a plurality of radial through openings 413 and a through central opening 417.

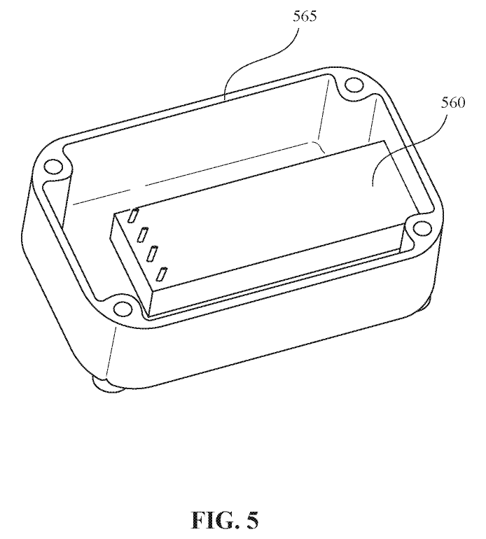

FIG. 5 illustrates a perspective view of an exemplary transducer, consistent with embodiments of the present disclosure. Transducer 560 may comprise a current transducer or a current sensor. Transducer 560 may include a circuit laid out on a printed circuit board, for example. Transducer 560 may be housed within enclosure 565, which is configured to be mounted on mount 315 (as discussed with reference to FIG. 3C). In some embodiments, the electronic circuit assembly including the printed circuit board may be epoxy potted or resin potted to provide protection, insulation, and structural support to electronic components.

FIG. 6 illustrates a perspective view of an example of a mounting structure, consistent with embodiments of the present disclosure. Mount 615 may include a portion 612 configured to receive a load cell, groove 616 configured to receive an end of an outer shield (e.g., outer shield 345 of FIG. 3C), a portion 618 configured to receive a transducer (e.g., transducer 560 of FIG. 5), and a plurality of support arms 690 configured to enable attachment of mount 615 to an adapter (e.g., adapter 205 of FIG. 2).

FIG. 7 illustrates a top view of a spacer 750, analogous to spacer 350 of FIG. 3A, consistent with embodiments of the present disclosure. Spacer 750 may be disposed in the gap ‘d’ between outer wall of inner tube 735 and inner wall of outer shield 745, depicted by circles of broken lines in FIG. 7. In some embodiments, a fluid level sensor may include a plurality of spacers. Spacer 750 may be coupled to a portion of the inner walls of outer shield 745 and to a portion of the outer walls of inner tube 735 such that it substantially minimizes or prevents relative movement between the inner tube 735 and outer shield 745. In some embodiments, the inner diameter S_{id} of spacer 750 may be substantially equal to slightly greater than the outer diameter of inner tube 735 and the outer diameter S_{od} of spacer 750 may be substantially equal to or slightly smaller than the inner diameter of outer shield 745.

As previously discussed with reference to FIG. 3A, spacer 750, analogous to spacer 350, may separate the inner tube 735 from outer shield 745 by the gap d, as shown in FIG. 7. One or more spacers may be used to maintain the gap d between inner tube 735 and outer shield 745 along the length of the inner tube 735 and the outer shield 745.

Reference is now made to FIG. 8, which illustrates a schematic of a transducer circuit 870, consistent with embodiments of the present disclosure. Transducer circuit 870 may be configured to convert a load cell signal to a 4-20 mA (milli Amperes) current loop. The signal conversion may include amplification of the load cell’s output signal, conditioning the signal, and converting it to a current signal within the 4-20 mA range.

Transducer circuit 870 may be divided into a load cell 825 (Wheatstone bridge sensor), an instrumentation amplifier 875, and a current loop transmitter 885. As previously discussed, a Wheatstone bridge is a circuit configuration comprising four resistive elements creating two voltage dividers in parallel between an excitation voltage and ground. The change in resistance, caused by change in the weight of submerged inner tube 335, may create a difference in voltage between the two dividers, V_{SIG+} and V_{SIG-}. A differential voltage measurement may be taken between the two points. A large differential voltage corresponds to a large variation in resistance, and thus a large change in the sensor value being measured.

Instrumentation amplifier 875 may be connected to a Wheatstone bridge to amplify the differential voltage developed by the bridge. Signal conditioning may include ensuring the amplified signal is within the desired range and format for the current loop converter, which in turn transforms the conditioned voltage into a 4-20 mA current signal.

Current loop transmitter 885 may be configured to transmit the 4-20 mA current signal through a 2-wire current loop to an external controller or a receiver.

The embodiments of the present disclosure may further be described using the following clauses:
1. A fluid level sensor, comprising:
   a first elongate structure comprising a first end and a second end opposite the first end, the first elongate structure configured to be at least partially submerged in a fluid such that the second end is fully submerged in the fluid; and
   a load cell coupled to the first end of the first elongate structure and configured to generate a first electrical signal indicating a level of submergence of the first elongate structure in the fluid.
2. The fluid level sensor of clause 1, further comprising a second elongate structure configured to surround the first elongate structure along a length of the first elongate structure.
3. The fluid level sensor of clause 2, wherein the first elongate structure and the second elongate structure are placed concentrically along a vertical axis.
4. The fluid level sensor of any one of clauses 2 or 3, wherein the first elongate structure and the second elongate structure are radially separated by a gap, and wherein the gap is substantially uniform along the length of the first elongate structure.
5. The fluid level sensor of any one of clauses 2 to 4, further comprising at least one spacer coupled to an outer wall of the first elongate structure and to an inner wall of the second elongate structure, and wherein the at least one spacer is configured to maintain uniformity of the gap.
6. The fluid level sensor of any one of clauses 1 to 5, wherein the load cell comprises circuitry configured to detect a change in buoyant force exerted on the first elongate structure caused by a change in the level of submergence of the first elongate structure.
7. The fluid level sensor of clause 6, wherein the load cell is further configured to detect a change in a weight of a submerged portion of the first elongate structure based on the change in buoyant force.
8. The fluid level sensor of any one of clauses 1 to 7, wherein the load cell comprises a strain gauge.
9. The fluid level sensor of clause 8, wherein the strain gauge is one of a quarter-bridge strain gauge, a half-bridge strain gauge, or a full-bridge strain gauge.
10. The fluid level sensor of any one of clause 2 to 5, further comprising a transducer electrically connected with the load cell, the transducer being configured to receive the first electrical signal and generate a second electrical signal based on the first electrical signal.
11. The fluid level sensor of clause 10, further comprising an enclosure configured to house the transducer.
12. The fluid level sensor of clause 11, further comprising a mount, wherein the load cell is coupled to a mount through a mechanical coupling mechanism.
13. The fluid level sensor of clause 12, wherein the mount is further configured to receive the enclosure including the transducer.
14. The fluid level sensor of clause 13, wherein the mount is further configured to receive the second elongate structure.
15. The fluid level sensor of clause 12, wherein the mount is configured to be coupled to an adapter associated with a fluid container containing the fluid.
16. The fluid level sensor of any one of clauses 2 to 5, wherein the second elongate structure comprises a tube.
17. The fluid level sensor of any one of clauses 1 to 16, wherein the first elongate structure comprises a polyvinyl chloride (PVC) pipe.
18. The fluid level sensor of any one of clauses 1 to 17, wherein the second end of the first elongate structure is sealed to prevent the fluid from entering the first elongate structure.
19. The fluid level sensor of any one of clauses 2 to 5, wherein the second elongate structure is longer than the first elongate structure.
20. A method for sensing level of a fluid in a fluid container using the fluid level sensor of any one of clauses 1 to 19. 1. A fluid level sensor, comprising:
21. A fluid management system, the fluid management system comprising:
   a fluid container configured to hold a fluid;
   a fluid level sensor configured to measure a level of the fluid in the container, wherein the fluid level sensor comprises:
      a first elongate structure comprising a first end and a second end opposite the first end, the first elongate structure configured to be at least partially submerged in the fluid such that the second end is fully submerged in the fluid, and
      a load cell coupled to the first end of the first elongate structure and
   configured to generate a first electrical signal indicating a level of submergence of
   the first elongate structure in the fluid; and
   a fluid pump configured to remove the fluid from the fluid container.
22. The fluid management system of clause 21, further comprising a fluid control unit configured to communicate with the fluid level sensor and the fluid pump to maintain a predetermined amount of the fluid in the fluid container.
23. The fluid management system of clause 22, wherein the fluid control unit activates the fluid pump when the fluid level sensor rises above a predetermined limit.
24. The fluid management system of any one of clauses 22 to 23, wherein the fluid control unit communicates with the fluid level sensor and the fluid pump by at least one of a remote connection, a wired connection, or a wireless connection.
25. The fluid management system of any one of clauses 21 to 24, further comprising an adapter configured to secure the fluid level sensor within the fluid container.
26. The fluid management system of clause 25, wherein the adapter comprises a riser.
27. The fluid management system of any one of clauses 25 to 26, wherein the fluid level sensor is coupled with the adapter by a mount.
28. The fluid management system of any one of clauses 21 to 27, further comprising a PID controller configured to continuously control the level of the fluid in the fluid container.
29. The fluid management system of any one of clauses 21 to 28, wherein a vertical axis of the fluid level sensor is aligned with a vertical axis of the fluid container.
30. The fluid management system of any one of clauses 21 to 29, wherein a vertical axis of the fluid level sensor is perpendicular to a horizontal surface of the fluid in the fluid container.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations and/or alterations based on the present disclosure. Other embodiments will be apparent from consideration of the specification and practice of the embodiments disclosed herein.

What is claimed is:

1. A fluid level sensor, comprising:
a first elongate structure comprising a first end and a second end opposite the first end, the first elongate structure configured to be at least partially submerged in a fluid such that the second end is fully submerged in the fluid; and
a load cell coupled to the first end of the first elongate structure and configured to generate a first electrical signal indicating a level of submergence of the first elongate structure in the fluid.

2. The fluid level sensor of claim 1, further comprising a second elongate structure configured to surround the first elongate structure along a length of the first elongate structure.

3. The fluid level sensor of claim 2, wherein the first elongate structure and the second elongate structure are placed concentrically along a vertical axis.

4. The fluid level sensor of claim 3, wherein the first elongate structure and the second elongate structure are radially separated by a gap, and wherein the gap is substantially uniform along the length of the first elongate structure.

5. The fluid level sensor of claim 4, further comprising at least one spacer coupled to an outer wall of the first elongate structure and to an inner wall of the second elongate structure, and wherein the at least one spacer is configured to maintain uniformity of the gap.

6. The fluid level sensor of claim 1, wherein the load cell comprises circuitry configured to detect a change in buoyant force exerted on the first elongate structure caused by a change in the level of submergence of the first elongate structure.

7. The fluid level sensor of claim 6, wherein the load cell is further configured to detect a change in a weight of a submerged portion of the first elongate structure based on the change in buoyant force.

8. The fluid level sensor of claim 1, wherein the load cell comprises a strain gauge.

9. The fluid level sensor of claim 8, wherein the strain gauge is one of a quarter-bridge strain gauge, a half-bridge strain gauge, or a full-bridge strain gauge.

10. The fluid level sensor of claim 2, further comprising a transducer electrically connected with the load cell, the transducer being configured to receive the first electrical signal and generate a second electrical signal based on the first electrical signal.

11. The fluid level sensor of claim 10, further comprising an enclosure configured to house the transducer.

12. The fluid level sensor of claim 11, further comprising a mount, wherein the load cell is coupled to a mount through a mechanical coupling mechanism.

13. The fluid level sensor of claim 12, wherein the mount is further configured to receive the enclosure including the transducer.

14. The fluid level sensor of claim 13, wherein the mount is further configured to receive the second elongate structure.

15. The fluid level sensor of claim 12, wherein the mount is configured to be coupled to an adapter associated with a fluid container containing the fluid.

16. The fluid level sensor of claim 2, wherein the second elongate structure comprises a tube.

17. The fluid level sensor of claim 1, wherein the first elongate structure comprises a polyvinyl chloride (PVC) pipe.

18. The fluid level sensor of claim 1, wherein the second end of the first elongate structure is sealed to prevent the fluid from entering the first elongate structure.

19. The fluid level sensor of claim 2, wherein the second elongate structure is longer than the first elongate structure.

20. A method for sensing level of a fluid in a fluid container using the fluid level sensor of claim 1.
